(19) United States
(12) Patent Application Publication
(10) Pub. No.: US 2017/0304999 A1
(43) Pub. Date: Oct. 26, 2017

(54) Fittings, Components, and Associated Tools

(71) Applicant: 3SC Global, LLC, Kilgore, TX (US)

(72) Inventors: Don William Broussard, Jr., Wynne, AR (US); Ronald Kent Swain, Kensett, AR (US); Jeffery Allen Bess, Longview, TX (US); Johnnie Rae Burrows, Longview, TX (US); Jerad Norman Richardson, Gladewater, TX (US)

(73) Assignee: 3SC Global, LLC, Kilgore, TX (US)

(21) Appl. No.: 15/584,836

(22) Filed: May 2, 2017

Related U.S. Application Data
(63) Continuation-in-part of application No. 15/372,925, filed on Dec. 8, 2016.
(60) Provisional application No. 62/265,656, filed on Dec. 10, 2015.

(51) Int. Cl. B25B 13/50; F16L 15/08; B25B 23/00

(52) U.S. Cl. CPC B25B 13/50; B25B 23/0007; F16L 15/08

(57) ABSTRACT

Described are fittings, components, and associated tools for use in coupling pipe or tubing. The described fittings generally include a unitary body having an outer surface and an inner lumen forming a void within said unitary body. The lumen is configured to receive threads for mating with the threads of a female sub end of a pipe or tube. The outer surface includes at least one aperture for receiving a tool that can be inserted within said aperture so as to rotate the fitting about an axis that extends through the lumen of the unitary body. The at least one apertures provide a safe and convenient way to tighten and loosen the fitting during the process of coupling pipe or tubing.

### CROSS-REFERENCE TO RELATED APPLICATIONS

This application is a continuation-in-part of U.S. patent application Ser. No. 15/372,925, filed Dec. 8, 2016, which claims the benefit of U.S. Provisional Patent Application Ser. No. 62/265,656, filed Dec. 10, 2015, each of which is hereby incorporated herein by reference in its entirety.

### BACKGROUND

### 1. Field of the Invention

The present invention is generally directed to fittings, components, and associated tools for use in coupling pipe and tubing.

### 2. General Background of the Invention

Pipe and tubing unions have many applications in fluid handling services. Such applications include potable water applications, such as joining copper tubing together, as well as more hazardous and sophisticated applications, such as joining piping together for hazardous service operations at high pressure.

One type of union that has gained popularity is the hammer union. As shown in FIGS. 1-2, the hammer union has a nut 1 that is disposed around a male sub end 3. The male sub end has a flange 5 that is configured to mate with a female sub end 7. The flange 5 has a diameter that is sufficient to permit the nut 1 to slide over the flange so as to dispose the nut on the male sub end 3. After placing the nut over the male sub end flange 5, a set of segments 9 can be mated together over the male sub end 3, and held in place with snap ring 11. The segments include a lip 13 that prevents the nut from sliding over the male sub end flange 5. Segments are not always used, however, such as where the male sub end flange is large enough to catch the hammer union nut and prevent it from sliding off the end of the male sub end.

Turning now to FIG. 2, after the segments are in place, the nut is tightened by first manually aligning the threads on the nut with the threads on the female sub end 7, and thereafter hitting three tabs on the nut with a sledge hammer until achieving a seal. Once the service application is complete, the pipe can be decoupled, again by use of a sledge hammer to loosen the fitting.

Problems can arise, however, from the use of hammer unions. For example, hammer unions are susceptible to fatigue caused by the repeated hitting of the nut part of the fitting with a sledge hammer. In some instances, the fatigue in the fitting can make it more difficult to form the seal between the male and female sub ends. In other instances, the fatigue can also lead to hairline cracks in the fitting. When leaks occur during operation of a system, a user has a tendency to again hit the hammer union nut with a sledge hammer in order to further tighten the union's seal to stop the leak. Under certain known high pressure oil and gas services, the hit to a fatigued hammer union under service conditions has caused an explosion to occur, which has unfortunately resulted in the death of those around the fitting.

Attempts have been made to overcome these and other deficiencies in hammer unions. For example, U.S. Pat. No. 6,764,109 to Richardson et al. discloses disposition of an o-ring seal between the female and male sub ends of a hammer union, so as to help prevent leakage via compression of the o-ring as the union is tightened.

U.S. Patent Application Serial No. 2015/0226355 to Ungchusri et al. discloses a hammer union that locates a plurality of load segments between a hammer union nut and the male sub end in order to help withstand horizontal loads occurring when the hammer union is assembled, thereby reducing fatigue in the union.

U.S. Pat. No. 6,945,569 to Diaz et al. discloses a hammer union where a segment interfaces with the union's nut and the male sub end flange in a conical arrangement in order to reduce stress in the nut segment so as to prevent deformation of the nut section of the union.

U.S. Pat. No. 9,186,780 to Dumaine et al. and U.S. Patent Application Serial No. 2014/0260817 to Wilson et al. disclose wrenches that can be disposed around the tabs of a hammer union to tighten and loosen the union without imparting the fatigue caused by the use of a sledge hammer.

U.S. Patent Application Serial No. 2008/0136168 to Ungchusri discloses a modified hammer union nut that includes a web having impact holes for receiving a sliding hammer that can be used to tighten and loosen the nut.

U.S. Patent Application Serial No. 2015/0369415 to Bond et al. discloses a restraint system for securing temporary flow lines that contain hammer union fittings. The system includes endless loop slings that are secured to the flow lines in order to arrest movement of the flow lines during a catastrophic failure of the flow line system.

In view of the background in this area, there remain needs for improved and/or alternative fittings, components, and associated tools for use in coupling pipe and tubing. The present invention is addressed to those needs.

### SUMMARY OF THE INVENTION

In one aspect, the invention relates to a tightening tool for use in tightening a fitting that includes a unitary body having a proximal end and a distal end. The distal end of the unitary body is configured for insertion into an aperture of a fitting or is configured to receive a protrusion of a fitting, where such fittings are for use in coupling pipe or tubing. The proximal end of the unitary body further includes an aperture or protrusion configured to receive a wrench for use in manipulating the tightening tool when the distal end of the tightening tool is inserted into an aperture (or receives a protrusion) of a fitting for use in coupling pipe or tubing.

In another aspect, the invention relates to a torqueing tool for use in tightening a fitting to a desired torque. The torqueing tool has an elongate body having a proximal end, a distal end, and a lumen. The lumen has a central axis that extends within the lumen between the proximal end and the distal end of the elongate body. A lock ring is disposed within the lumen of the elongate body, where the lock ring is configured to move in a bidirectional manner along the central axis of the lumen. An adjustment screw is disposed within the lumen of the elongate body, where the adjustment screw is configured to releasably interface with the lock ring so as to permit adjustment of the adjustment screw when the lock ring is disengaged from the adjustment screw and to prevent adjustment of the adjustment screw when the lock ring is engage with the adjustment screw. A torque arm having a proximal end, a distal end, and a body is located at the distal end of the torqueing tool, with the proximal end of the torque arm being disposed within the lumen of the elongate body. The distal end of the torque arm is configured for insertion into an aperture of a fitting or is configured to receive a protrusion of a fitting, where such fittings are for use in coupling pipe or tubing.

### BRIEF DESCRIPTION OF THE DRAWINGS

FIG. 1 provides a cross-sectional view of a prior art hammer union.

FIG. 2 provides a perspective view of a prior art hammer union.

FIG. 3A provides a perspective view of an illustrative embodiment of the invention.

FIG. 3B provides a right hand elevation view of the illustrative embodiment in FIG. 3A.

FIG. 3C provides a front elevation view of the illustrative embodiment depicted in FIG. 3A.

FIG. 3D provides a rear elevation view of the illustrative embodiment depicted in FIG. 3A.

FIG. 4A provides a right hand elevation view of an illustrative embodiment of the invention.

FIG. 4B provides a rear elevation view of the illustrative embodiment depicted in FIG. 4A.

FIG. 5 provides a cross-sectional view of an illustrative embodiment of the invention.

FIG. 6 provides a perspective view of an illustrative embodiment of the invention.

FIG. 7A provides a perspective view of an illustrative embodiment of the invention.

FIG. 7B provides a right hand elevation view of the illustrative embodiment in FIG. 7A.

FIG. 7C provides a perspective view of the illustrative embodiment in FIG. 7A.

FIG. 8A provides a perspective view of an illustrative embodiment of the invention.

FIG. 8B provides a front elevation view of the illustrative embodiment of FIG. 8A.

FIG. 9A provides a side view of an illustrative embodiment of the invention.

FIG. 9B provides a cross-sectional view of the illustrative embodiment in FIG. 9A.

FIG. 9C provides an exploded view of the illustrative embodiment in FIG. 9A that has been rotated 90 degrees.

FIG. 9D provides a side view of an illustrative torque arm of the invention.

FIG. 9E provides a side view of an illustrative doubler arm of the invention.

FIG. 9F provides a side view of an illustrative pawl block of the invention.

FIG. 9G provides a side view of an illustrative spring guide of the invention.

FIG. 9H provides a side view of an illustrative torque spring of the invention.

FIG. 9I provides a side view of an illustrative push rod foot of the invention.

FIG. 9J provides a side view of an illustrative push rod of the invention.

FIG. 9K provides a side view of an illustrative adjustment housing of the invention.

FIG. 9L provides an end view of the adjustment housing depicted in FIG. 9K.

FIG. 9M provides a cross-sectional view taken along line A-A of the adjustment housing depicted in FIG. 9L.

FIG. 9N provides a side view of an illustrative lock ring spring of the invention.

FIG. 9O provides a front elevation view of an illustrative lock ring of the invention.

FIG. 9P provides a cross-sectional view taken along line A-A of the lock ring depicted in FIG. 9O.

FIG. 9Q provides a perspective view of an illustrative adjustment screw of the invention.

FIG. 9R provides a front elevation view of the adjustment screw depicted in FIG. 9Q.

FIG. 9S provides a side view of the adjustment screw depicted in FIG. 9Q.

FIG. 9T provides a side view of an illustrative adjustment tool of the invention.

FIG. 9U provides a side view of an illustrative cap of the invention.

FIG. 10A provides a perspective view of an illustrative calibration adapter and torqueing tool of the invention connected to a calibration tool.

FIG. 10B provides a partial front elevation view of an illustration torqueing tool of the invention connected to a calibration tool.

FIG. 10C provides a partial side view of embodiment depicted in FIG. 10B.

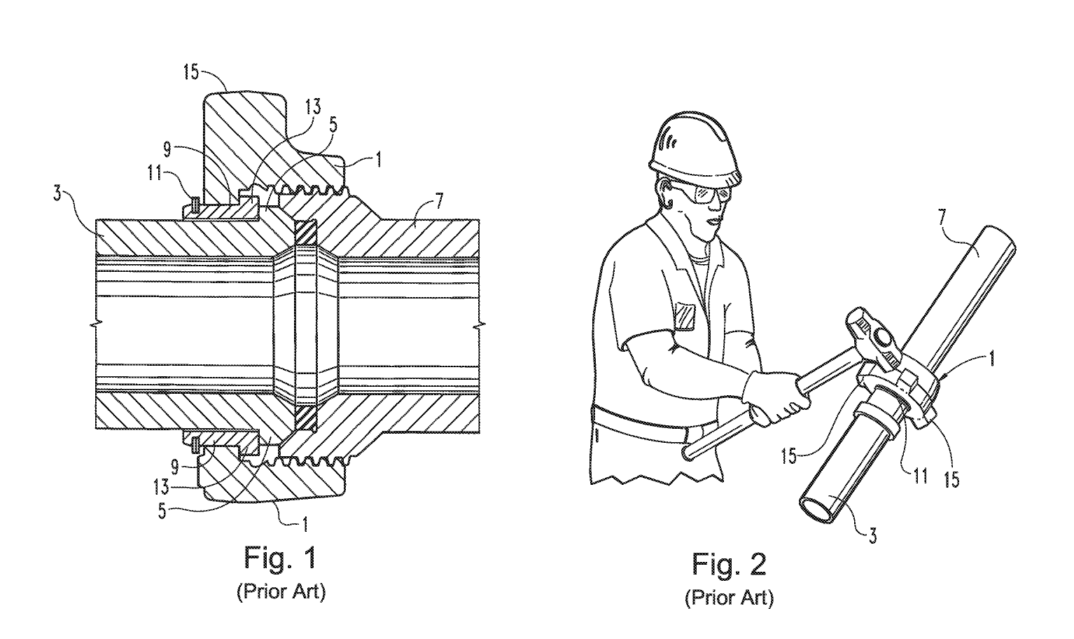

### DETAILED DESCRIPTION

For the purposes of promoting an understanding of the principles of the invention, reference will now be made to certain embodiments thereof and specific language will be used to describe the same. It will nevertheless be understood that no limitation of the scope of the invention is thereby intended, such alterations, further modifications and further applications of the principles of the invention as described herein being contemplated as would normally occur to one skilled in the art to which the invention relates.

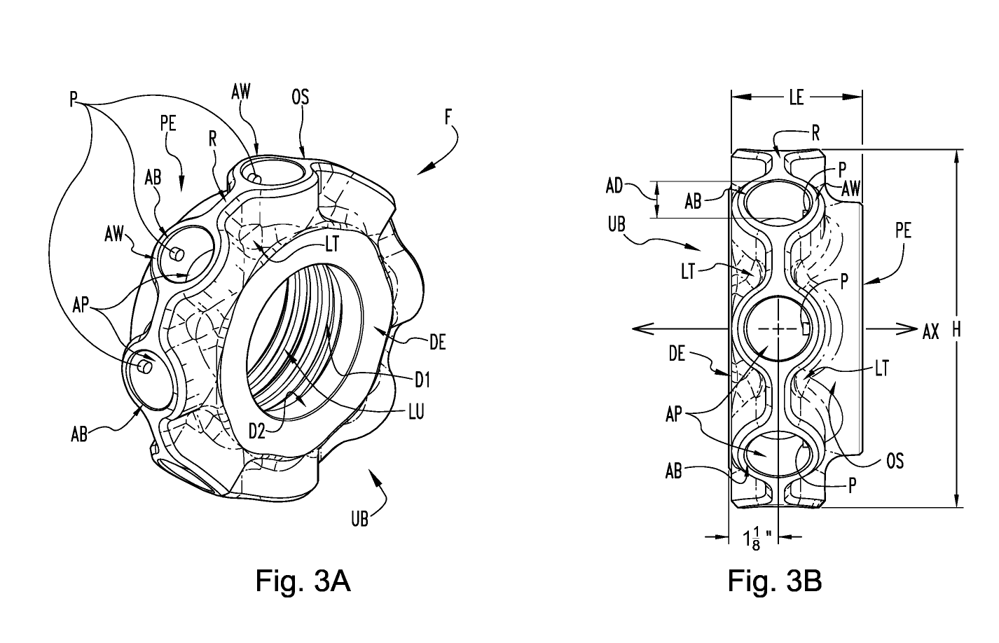

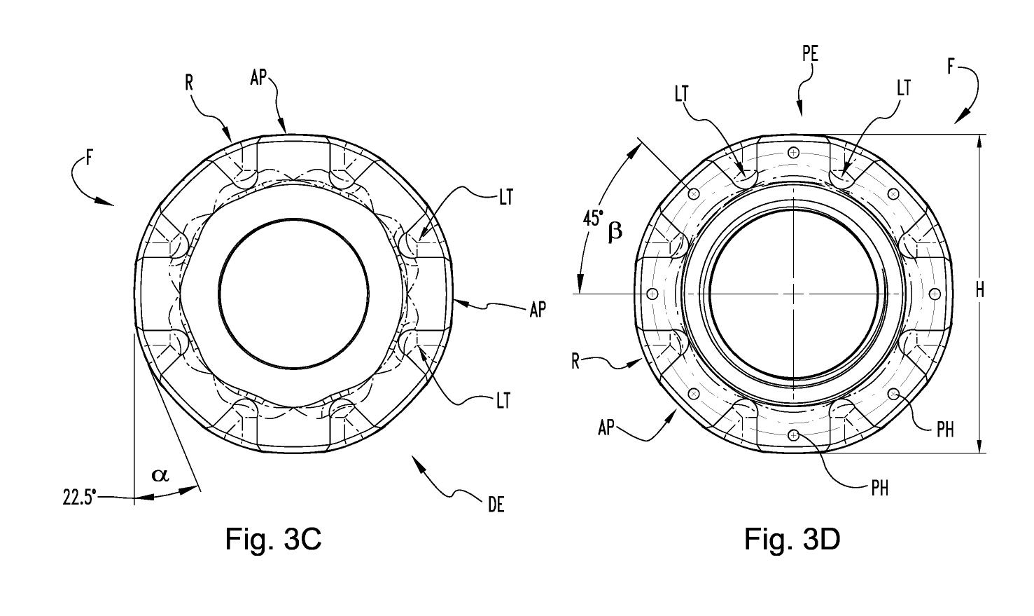

FIG. 3A depicts a perspective view of an illustrative fitting F of the invention, and FIG. 3B depicts a right hand elevation view of the embodiment depicted in FIG. 3A. As shown, the fitting F includes a unitary body UB having a length LE, a distal end DE, a proximal end PE, an outer surface OS, and a lumen LU. The outer surface OS generally extends around the length of the unitary body UB and across the face of the proximal and distal ends PE, DE.

The fitting F has a lumen LU that extends within the unitary body UB from the proximal end PE to the distal end DE so as to permit the flow of a fluid through the unitary body UB. The lumen LU is cylindrical and occupies a first diameter D1 and a second diameter D2. The first diameter D1 is greater than the second diameter D2, and the first diameter D1 includes threads that are configured to receive a threaded female sub end of a pipe (not shown). The threads start at the proximal end PE of the unitary body UB and extend distally into the first diameter D1 of the lumen LE and end at a proximal location from the distal end DE, at approximately the beginning of the second diameter D2, but the threads may terminate at any suitable location within the lumen LU.

The second diameter D2 can be such a size so as to catch the flange on a male sub end (not shown) in a manner to prevent the fitting F from being able to slide over the flange of the sub end. Alternatively, the second diameter D2 may be of sufficient size to permit the fitting F to slide over the flange of a male sub end, so as to permit the fitting F to be readily replaced or exchanged with another fitting F. In this embodiment, a set of segments (not shown) can be disposed around the male sub end to form a stop that catches the fitting F and prevents it from slipping off the male sub end during installation.

The unitary body UB depicted in FIGS. 3A and 3B also includes eight apertures AP disposed along the outer surface OS of the unitary body UB in a manner so as to form a part of the topography of the outer surface OS of the unitary body UB. Each aperture AP extends from the outer surface OS of the unitary body UB and ends within the unitary body UB. Each aperture AP is configured to receive a tool 100, as described herein, for rotating the fitting F around an axis AX that extends from the distal end DE to the proximal end PE so as to permit the tightening and loosening of the fitting F to a threaded female sub end of a pipe or tube. As shown in FIGS. 3A-3B, the axis AX extends along the center-line of the unitary body UB, however, in certain embodiments, the axis AX may be off-set, such as may be useful in an application where the lumen LU of unitary body UB is offset from the center line of the unitary body UB.

As shown in FIGS. 3A-3B, each aperture AP includes a protrusion P that extends from the wall AW of the aperture AP into the aperture AP. The protrusion P is of sufficient diameter and sufficiently extends into the aperture AP so as to releasably secure the tool 100 that can be used to loosen or tighten the fitting F. Although each depicted aperture AP is generally of a cylindrical shape, any shape may be used. Suitable such shapes can include rectangles, cubes, triangular and square based prisms, rectangular prisms, hexagonal prisms, elongated cylinders, cones, partial spheres, and the like. Moreover, the apertures AP may take any suitable form so as to permit a tool 100 to releasably engage the aperture AP so as to rotate fitting F around the axis AX and secure the seal between the male and female sub ends (not depicted). The apertures AP depicted in FIGS. 3A-3B have a sufficient depth AD and the walls of the apertures AW have sufficient thickness so as to permit the tool 100 to provide sufficient force so as to tighten the fitting F in a manner that seals the interface of the male and female sub ends without damaging the apertures AP or their walls AW.

Additionally, the apertures AP depicted in FIGS. 3A-3B have a bevel AB located along the inner wall of the aperture AP at the opening of the aperture AP. The bevel AB assists a user with insertion of the tool 100 within the aperture AP. In other embodiments, the bevels AB are not included, such as where the tool 100 is designed for easy insertion into the apertures AP.

As also shown in FIGS. 3A-3B, the outer surface OS of the fitting F also includes lower topographical LT portions that are adjacent to the walls AW of the apertures AP. The depth of the lower topographical LT portions can be varied, along with the aperture depth AD and thickness of the aperture wall AW so as to provide fittings F that are suitable for varying applications. In some applications, for example, a low profile may be needed for the fitting F, and in these applications, the depth of the apertures AD may need to be minimized and may even result in the elimination of lower topographical LT portions adjacent to the aperture wall AW. In normal clearance applications, the topography of the outer surface OS will typically provide for the presence of lower topographical LT portions adjacent to the aperture wall AW.

FIG. 3C provides a front elevation view of the distal end DE of the fitting F illustrated in FIG. 3A, and FIG. 3D provides a rear elevation view of the proximal end PE of the fitting F illustrated in FIG. 3A. As shown in FIGS. 3C-3D, the openings of each aperture AP occupy the same elevation of the outer surface OS so as to form a relatively flat overall opening height at each aperture AP. Each aperture AP is connected at its opening with a ridge R that extends from the lower topography LT between the apertures AP to the opening of the aperture AP. Although the depicted ridges R reach the aperture AP openings, in other embodiments, the ridges R may not reach the aperture AP openings, and may even occupy the same elevation as the lower topographies LT. In fact, in certain embodiments, the fitting F can have apertures AP that vary in height as compared to one another, if desirable.

As depicted in FIGS. 3C-3D, the fitting F appears generally circular from the side, and has a height H as can be measured by standing the fitting F on an opening of an aperture AP. Although the depicted fitting F appears circular from the side, the fitting F topography may vary thereby causing the side view to vary. For example, the number of apertures AP can vary from a single aperture AP, to more than eight. In an embodiment comprising only three apertures AP, for example, the side view of the fitting F may appear triangular, such as where the ridge R connecting the apertures AP has an elevation similar to the lower topography LT between the apertures AP. Likewise, a fitting F having only four apertures AP may have a square-like side view, such as where the ridges R extend to openings of the apertures AP and maintain their height between apertures AP.

Returning to FIGS. 3C-3D, the top surface of each ridge R line departs from the aperture wall AW at an angle of 22.5 degrees α, and given that the fitting F has eight apertures AP, they are generally disposed around the fitting F every 45 degrees β.

Turning to FIG. 3D, the each wall AW of each aperture AP on the proximal end of the fitting F includes a hole PH for locating the protrusion P into the aperture AP. In the depicted embodiment, the protrusion hole PH is one-quarter (¼) inches in diameter and the protrusion P is pressed into the hole using conventional techniques, such that it extends a distance of roughly five-thirty seconds ( 5/32) of an inch into the aperture AP. The hole PH can be any suitable shape, however, depending on the shape of the protrusion P, e.g. cylindrical, cuboid, or the like, and can be of any suitable dimension to accommodate the protrusion P. Moreover, the protrusion P may be formed into the fitting F during casting, as discussed below, thereby eliminating the need for a protrusion hole PH. In certain embodiments, the apertures AP can include two protrusion holes PH, such as when it is desirable for the protrusion P to extend across the diameter of the aperture AP. These embodiments can be desirable such as when the depth of the apertures AD are minimal and the tool 100 end is configured to catch the protrusion P so as to rotate the fitting F. Additionally, a fitting F can be constructed without any protrusions P, or may optionally include protrusions P in a subset of the total number of apertures AP on the fitting F.

As discussed herein, the fitting F can be modified to accommodate a variety of different services. For example, the dimensions of the fitting F depicted in FIGS. 3A-3D can be varied to accommodate the coupling of different sized pipe. The following table provides dimensions for an illustrative subset of piping applications.

| Pipe Size | 2″ | 3″ | 4″ |
|---|---|---|---|
| H | 7⅛″ | 8¼″ | 10⅝″ |
| LE | 2⅝″ | 2¾″ | 3¾″ |
| AP Diameter | 1¼″ | 1¼″ | 1¼″ |
| AD | 1⅛″ | 1⅛″ | 1⅛″ |
| AW thickness | 5/32″ | 5/32″ | 5/32″ |

As shown in the above table, the thickness of the aperture's wall AW, the diameter of the aperture AP, and the depth of the aperture AD, do not typically vary across different fitting F sizes. In some embodiments, however, it may be desirable to vary some of these dimensions depending on the overall fitting F design, such as its overall height, etc. As such, any suitable dimensions may be used in illustrative embodiments of the inventions, including but not limited to aperture AP diameters of one-half (1/2) inch, three-quarters (3/4) of an inch, one (1) inch, one and a half (1½) inches, one and three-quarters (1¾) of an inch, or two (2) inches and the like. The depth of the aperture AD can be varied in a similar manner.

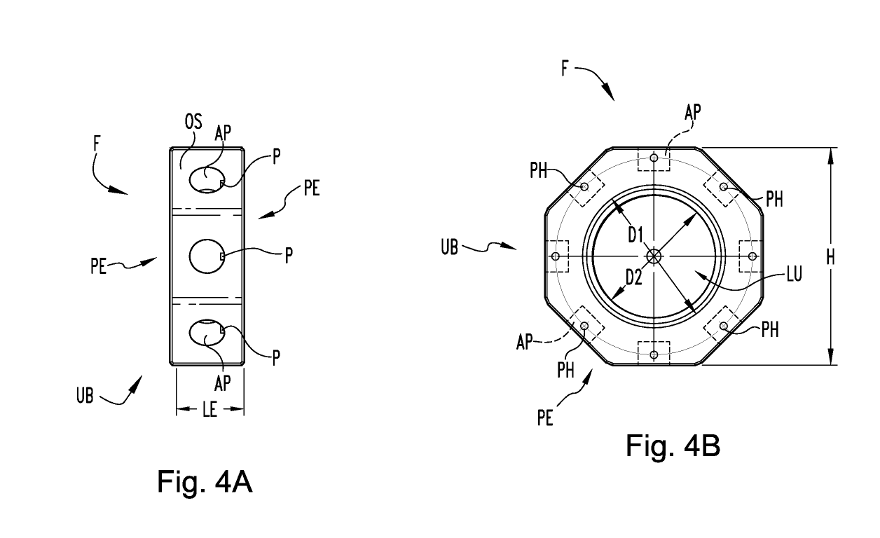

FIG. 4A depicts a right hand elevation view of an illustrative fitting F of the invention, and FIG. 4B depicts a rear elevation view of the embodiment depicted in FIG. 4A. The depicted fitting F includes eight apertures AP, each of which includes a protrusion P for releasably securing a tool 100 for rotating the fitting F about an axis. The proximal end PE of the fitting F includes holes PH that secure the protrusions P into the fitting F, such as by way of a compression fitting F. The fitting F also has a distal end, which like the proximal end is generally flat. The fitting F appears generally octagonal from the side, and has a height H as can be measured by standing the fitting F on an opening of an aperture AP. The fitting F includes a unitary body UB having an outer surface OS that is of the same general elevation along the length LE of the unitary body UB, so as to eliminate any lower topography areas LT along the outer surface OS. The fitting F also has a cylindrical lumen LU having a first diameter D1 and second diameter D2. The first diameter D1 is greater than the second diameter D2, and the first diameter D1 includes threads that are configured to receive a threaded female sub end of a pipe (not shown). The threads start at the proximal end PE of the unitary body UB and extend distally into the first diameter D1 of the lumen LE and end at a proximal location from the distal end DE, at approximately the beginning of the second diameter D2.

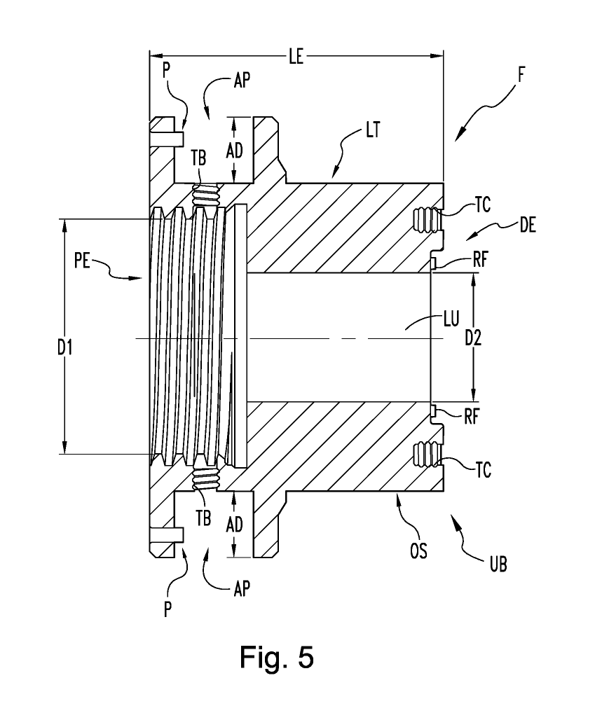

FIG. 5 depicts a cross-sectional view of an illustrative fitting F of the invention. The fitting F has a unitary body UB having a length LE, a distal end DE, a proximal end PE, an outer surface OS, and a lumen LU. The outer surface OS extends around the length LE of the unitary body UB and across the face of the proximal end PE and the face of the distal end DE.

The fitting F has a lumen LU that extends within the unitary body UB from the proximal end PE to the distal end DE so as to permit the flow of fluid through the unitary body UB. The lumen LU is cylindrical in shape and occupies a first diameter D1 and a second diameter D2. The first diameter D1 is greater than the second diameter D2, and the first diameter D1 includes threads that are configured to receive threaded pipe. The threads start at the proximal end PE of the unitary body UB and extend distally into the first diameter D1 of the lumen LU.

The second diameter D2 is smaller than the first diameter D1 and uniformly extends to the distal end DE of the unitary body UB, where the unitary body UB is configured to connect to a flange on a piece of equipment (not shown). The distal end DE of the unitary body UB includes threaded recesses TC for receiving bolts to secure the flange of the equipment to the unitary body UB and can also include a raised face RF to help seal the flange connection when made up.

The depicted fitting F also includes a plurality of apertures AP disposed circumferentially around the proximal end PE of the unitary body UB. Each of the apertures AP extends from the outer surface OS of the unitary body UB and terminates at a location within the unitary body UB. Each aperture AP has a depth AD that is sufficient to receive a tool 100 for rotating the fitting F to tighten the threads of the proximal end PE to a pipe. Each aperture AP also includes a threaded bore TB that connects the aperture AP to a portion of the threads that reside beneath the aperture AP. The unitary body UB has a length LE that is sufficient for the service and can illustratively be three (3) inches, four (4) inches, five (5) inches, or the like.

The unitary body UB also has a lower topographical region LT that is located distally of the outer surface OS that includes the apertures AP. As is the case for the illustrative embodiment of FIGS. 3A-3D, the outer surface OS of the unitary body UB of FIG. 5 can also include lower topographical LT regions between the aperture AP openings and ridges R (not shown).

In use, the proximal end PE of the fitting F depicted in FIG. 5 can be connected to the swivel head of a power swivel, such as a Logan 85 ton power swivel and tightened using an illustrative tool 100 of the invention. Once secure, threaded set bolts, which can include any suitable metal or polymer material, such as Teflon®, can be seated in the threaded bores TB of the fitting F. The set bolts are used to keep the swivel from backing out of the threaded part of the fitting F when it changes rotational direction. In this application, the distal end DE of the fitting F can be connected to an R&H Machine high pressure Swivel Assembly No. 10627-13 of Snubbing Swivel Style, which will permit the fitting F to rotate with the swivel head.

As illustrated, the length LE of the FIG. 5 fitting F is greater than the length of the fittings F of FIGS. 3A-3D and 4A-4B, and fitting lengths LE can vary depending on the particular application. Additionally the location of the apertures AP in relation to the length LE of the fitting F may also vary, and the apertures AP can be located within the same plane or can alternatively be offset from one another, again depending on the application and number of apertures AP on any particular fitting F. Although the lumen LU of the illustrated fittings F are generally cylindrical, the lumens can vary so as to occupy any void suitable for the service. For example, in some instances the lumen may form a T shape so as to permit multiple fluid exits in the FIG. 5 embodiment. Alternatively, the lumen may curve 90 degrees so as to permit a change in fluid direction through the fitting F. The lumen may also form a wide spot within the fitting F and then neck down at the outlet of FIG. 5, again depending on the service. Finally, the distal end of FIG. 5 can include any suitable fitting F to mate with another component, be it a threaded connection or a flange for bolting with a reciprocal flange on the other component.

The fittings F of the invention may be made of any suitable materials, such as copper, nickel, chromium, molybdenum, tungsten, carbon steel, stainless steel, such as 316 stainless, aluminum, and alloys or mixtures thereof, such as 4118, 4120, 4121, 4130, 4135, 4137, 4140, 4142, 4145, 4147, 4150, 4161 alloy steel and the like.

Certain embodiments of the invention also include a polymeric segment that can be used to cover the apertures AP of the fitting F and protect them from environmental conditions, such as rain followed by freezing conditions. Such segment can include raised areas that fit into each of the apertures AP and can easily be removed from the apertures AP. The segment can also include a portion for connecting the two ends of the segment after installation, such as interlocking pieces located at each end of the segment. Illustratively, the fitting F of the invention can also include drain ports located appropriately in the fittings F, such as at the bottom of each aperture AP, to serve as a drain for each of the apertures AP to avoid any damage from freezing conditions and the like.

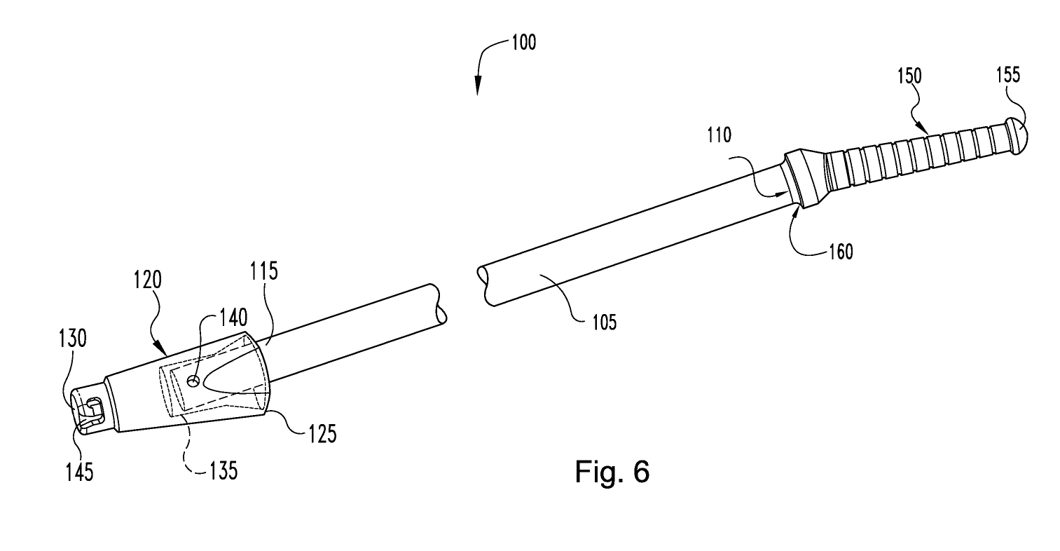

Turning now to FIG. 6, depicted is a tool 100 for use in tightening or loosening a fitting F that couples pipe or tubing. The tool 100 includes a bar 105 having a cylindrical elongate body, a proximal end 110, and a distal end 115. The tool 100 further comprises a bell head 120 having a proximal end 125 and a distal end 130. The proximal end 125 of the bell head 120 includes an aperture 135 that receives the distal end 115 of the elongated body 105. The distal end 115 of the elongated body 105 is affixed in the aperture 135 by a pin that is pressed into the bell head 120 after its disposition in the distal end 115 of the elongated body 105, such that the elongate body 105 can swing back and forth in a bi-direction manner within the aperture 135. Such swing can permit a user to gain some momentum on the elongate body when loosening a fitting F in order to help break the fitting F loose from its connection.

The distal end 130 of the depicted bell head 120 is cylindrical and is sized and configured to fit into an aperture AP of a fitting F described above. The distal end 130 of the bell head 120 also includes a “J” channel 145 for receiving a protrusion P of an aperture AP of a fitting F described herein. The “J” channel 145 permits the tool 100 to releasably interlock with the fitting F, such as when a user rotates the tool 100 while placing it into the aperture AP. In other embodiments, the distal end 130 of the bell head 120 can include other structures to releasably connect the tool 100 with the fitting F. In some embodiments, for example, the protrusion P can be spring loaded and the distal end 130 of the bell head 120 can include a small recess for mating with the spring loaded protrusion P so as to releasably connect the fitting F and the tool 100.

A valve tool 150 is depicted in FIG. 6 at the proximal end 110 of the elongate body 105. The valve tool 150 includes a distal end 160 and a proximal end 155, and occupies a diameter that narrows in a proximal direction from the distal end 160 of the valve tool 150 so as to permit the valve tool 150 to slide into the actuators of various sized ball valves to permit the operation of the valves.

The elongate body 105 can also include ridges R (not depicted), such as may run the length of the body in a diamond formation, to facilitate gripping of the bar, and the elongate body can also include a bore (not depicted) for use in connecting the bar to a safety lanyard. The tool 100 can be made of any suitable material, including carbon and stainless steel and their alloys.

The fittings F, bell head 120, and valve tool 150 can be formed during any suitable alloy casting process, such as sand casting or investment casting, as are known in the art. Illustrative sand casting processes include forming a mold of the component to be made in sand, followed by pouring molten metal into the casting so as to create a rough form of the component. Illustrative investment casting process include forming a wax pattern of the component to be made. A ceramic material is then coated onto the wax to make a mold for casting, and the wax is melted and removed from the mold. Molten metal is then poured into the ceramic mold and then cast to form the component. Investment casting techniques are suitable to form the fitting F and bell head 120 of the invention because they permit the castings to include the apertures AP discussed herein, thereby eliminated the step of boring the aperture AP into the fitting F and bell head 120 as discussed below, however either casting process can be used to form the components of the invention.

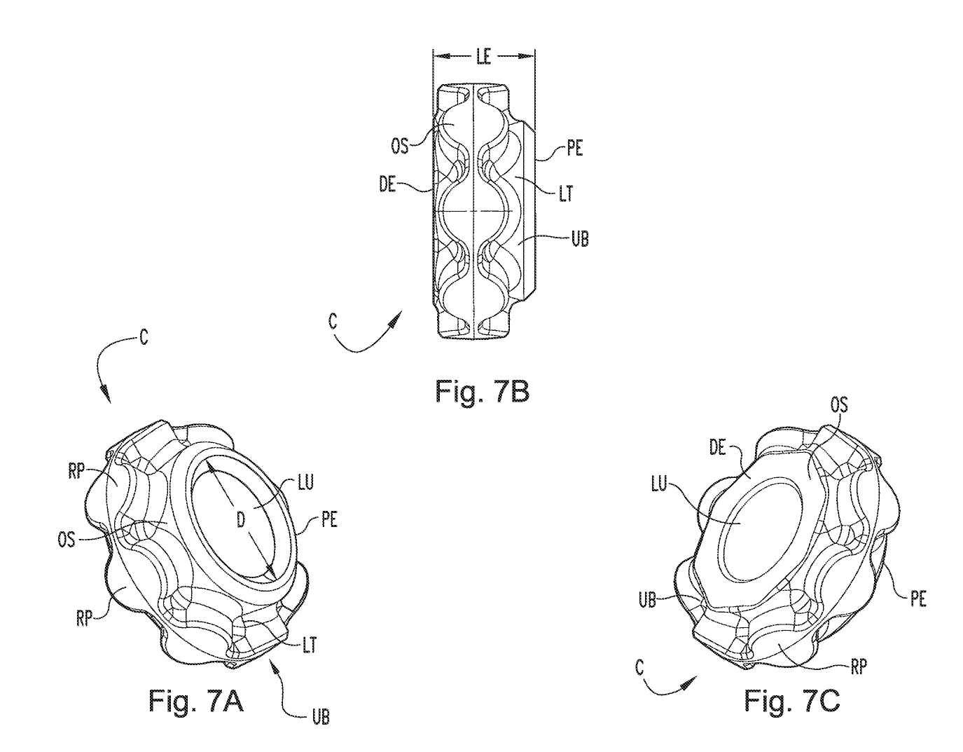

FIGS. 7A-7C depicts an illustrative casting C of a fitting F of the invention. The casting C forms a unitary body UB that has a length LE, a distal end DE, a proximal end PE, an outer surface OS, and a lumen LU. The outer surface OS extends around the length LE of the unitary body UB and across the face of the proximal and distal ends PE, DE, respectively. The lumen LE extends from the distal end DE of the unitary body UB to the proximal end PE of the unitary body UB so as to define a void within the unitary body UB.

The outer surface OS includes eight raised portions RP that extend radially outward from the center line of the lumen LU so as to raise the outer surface OS of the unitary body UB at each raised portion RP. The outer surface OS is also cast to include lower topographical portions LT that are adjacent to the raised portions RP. Each raised portion RP in the depicted FIGS. 7A-7B is cast as solid metal and is configured for boring so as to create an aperture AP in each raised portion RP. In alternative embodiments, as discussed above, the apertures AP can be cast into the fitting F so as to eliminate the boring step.

The lumen LU of the depicted casting C is cylindrical and includes a diameter D and is configured for threading using any suitable machining techniques as are known in the art. After the casting C of the FIG. 7A-7C embodiment is completed, each aperture AP is then bored using any suitable machining techniques as are known in the art and such bores can be made as part of the same process that locates threads into the diameter D of the lumen's LU proximal end PE. Additionally, protrusion holes PH can be drilled into the aperture walls AW after boring for receipt of the protrusions P which can be pressed through such holes, again using any suitable machining techniques.

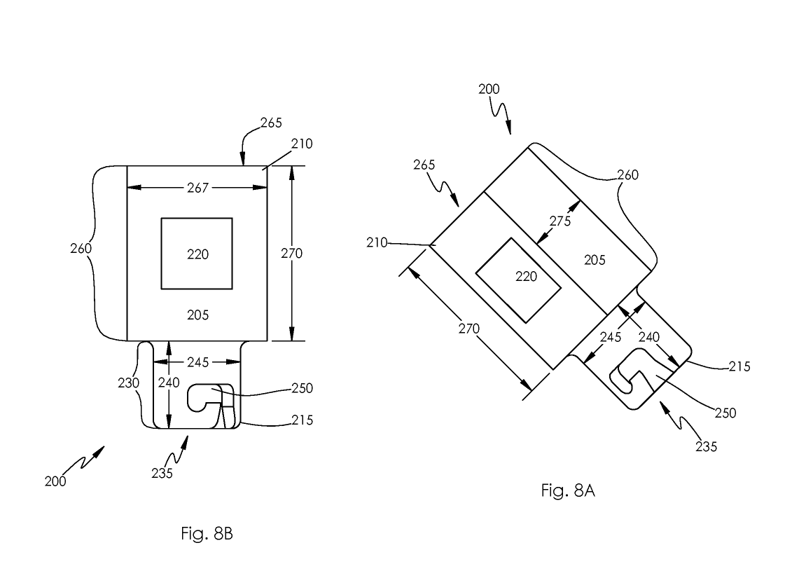

Turning now to FIGS. 8A and 8B, depicted is an illustrative tightening tool 200 for use in tightening or loosening a fitting F that couples pipe or tubing. The tightening tool has a unitary body 205 that has a proximal end 210 and a distal end 215. The distal end 215 of the unitary body 205 is configured for insertion into an aperture AP of a fitting F for use in coupling pipe or tubing. The proximal end 210 of the unitary body 205 includes an aperture 220 for receiving a wrench (not depicted) for use in manipulating the tightening tool 200 when the distal end 215 of the tightening tool 200 is inserted into an aperture AP of a fitting F that is used in coupling pipe or tubing.

The distal end 215 of the depicted unitary body 205 can occupy any suitable geometrical shape, such as the depicted cylindrical portion 230 that is shaped to fit within a cylindrical aperture AP of a fitting F described herein, such as those depicted in FIGS. 3A and 3B. The cylindrical portion 230 can include a face 235 located at the distal end 215 of the unitary body 205, and a length 240 that extends in a proximal direction from the face 235 that defines the wall of the cylindrical portion 230. The cylindrical portion 230 can include a diameter 245 that can be either uniform or variable along the length 240 of the cylindrical portion 230. The cylindrical portion 230 can also include a channel 250 for receiving a protrusion P in an aperture AP of a fitting F, such as a fitting F depicted in FIGS. 3A-3B. In certain embodiments, the channel 250 can occupy a “J” configuration so as to permit the tightening tool 200 to releasably interlock with a fitting F, such as when a user rotates the tightening tool 200 while placing it into an aperture AP.

In other embodiments, the distal end 215 of the tightening tool 200 can include other structures to releasably connect the tightening tool 200 with a fitting F, such as those described herein. In some embodiments, for example, such as where a protrusion P is spring loaded, the distal end 215 of the tightening tool 200 can include a small recess for mating with the spring loaded protrusion P so as to releasably connect a fitting F and the tightening tool 200. In other embodiments, the distal end 215 may include an aperture for receiving a portion of a fitting F, such as where the fitting includes one or more protrusions for tightening and/or loosening the fitting. Additionally, the distal end 215 may be configured in any suitable configuration for receiving an aperture AP or protrusion, and may therefore occupy any suitable geometrical shape or void such as a rectangle, cube, triangular and square based prisms, rectangular prisms, hexagonal prisms, elongated cylinders, cones, partial spheres, and the like. Moreover, the distal end 215 may include a structural component, such as a hook, claw, or the like, to catch a protrusion P within an aperture AP, such as where the protrusion P extends throughout the diameter of an aperture AP having a minimal aperture depth AD.

In certain embodiments, the distal end 215 of the unitary body 205 may be rounded such as to facilitate the entry of the distal end 215 into an aperture AP.

Returning to FIGS. 8A-8B, the proximal end 210 of the unitary body 205 can occupy any geometrical shape, such as the depicted rectangular prism 260. In the depicted embodiment, the rectangular prism 260 has a face 265 located at the proximal end 210 of the unitary body 205, a length 270 that extends in a distal direction from the cylindrical portion 230 of the distal end 215, and a width 275, that in certain embodiments, is constant across the length 270 of the rectangular prism 260. In alternative embodiments, however, the width 275 may vary in any suitable manner across the length 270 of the rectangular prism 260. Additionally, in the depicted embodiment, the width 275 of the rectangular prism 260 is equal to the diameter 245 of the cylindrical portion, but again, in other embodiments, such dimensions may vary from one another to form any suitable configuration for use in tightening or loosening fittings F.

The face 265 in the depicted embodiment has its own length 267 which may vary in order to accommodate any suitable shape and or corresponding dimensions. In the depicted embodiment the face length 267 is less than the rectangular prism length 270, but in alternative embodiments, the face length 267 can be greater than or equal to the rectangular prism length 270.

In the depicted embodiment, the aperture 220 of the tightening tool 200 extends throughout the entirety of the width 275 of the rectangular prism 260, and takes the shape of a rectangular prism so as to receive the end of a wrench (not depicted). In other embodiments, the aperture 220 may not extend throughout the entirety of the width 275 of the rectangular prism, and may instead terminate within the width 275 of the prism. Additionally, the aperture may occupy any suitable dimensions and shape so as to accommodate a wrench, such as the tab of a socket wrench (not depicted), for use in applying force to the tightening tool 200. The aperture may also be rounded at the interface of the aperture to the outer surface or surfaces of the width 275 so as to facilitate entry of a wrench tab into the aperture. In other embodiments, instead of or in addition to an aperture, the tightening tool 200, may also include one or more protrusion extending as part of the width 275 of the rectangular prism 260 for receiving a socket of a wrench for use in manipulating the tightening tool 200 so as to tighten or loosen a fitting F.

Illustratively, the diameter 245 of the cylindrical portion 230 of the distal end may be approximately 1.25 inches, and the length 240 of the cylindrical portion 230 may be approximately 1.25 inches. The length 270 of the rectangular prism 260 may be approximately 2.5 inches, the width 275 of the rectangular prism may be may be approximately 1.25 inches, and the length 267 of the rectangular prism's face 265 may be 2 inches. The aperture 220 may have a cross-sectional dimension of 1 inch by 1 inch throughout the entirety of the width 275 of the rectangular prism 260, and the channel 250 can occupy a depth of approximately 0.25 inches.

The tightening tool 200 can be made of any suitable material, including carbon and stainless steel and their alloys. The tightening tool 200 can also be formed during any suitable alloy casting process, such as sand casting or investment casting, as are known in the art and as are described herein. Although the depicted embodiment is a unitary body, such as can be made through suitable casting techniques, in other embodiments, the tightening tool 200 may be assembled from one or more pieces, such as may be separately cast and then assembled to form the tightening tool 200 described herein.

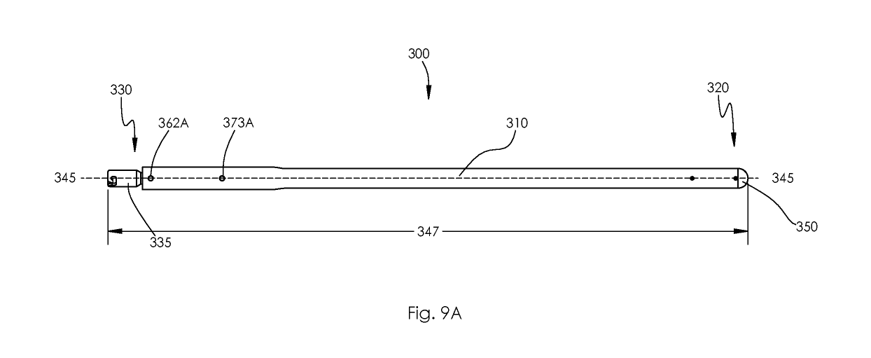

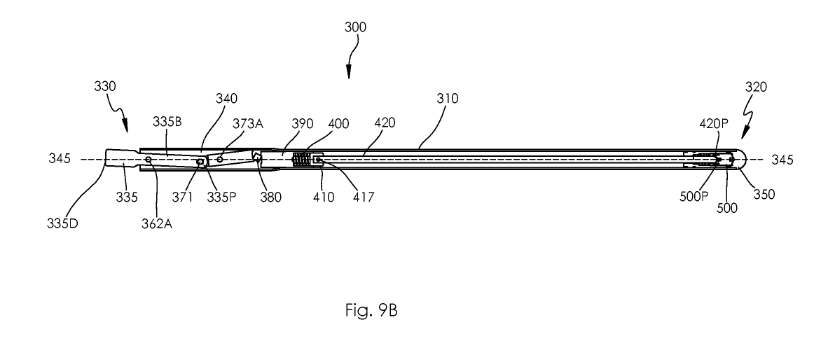

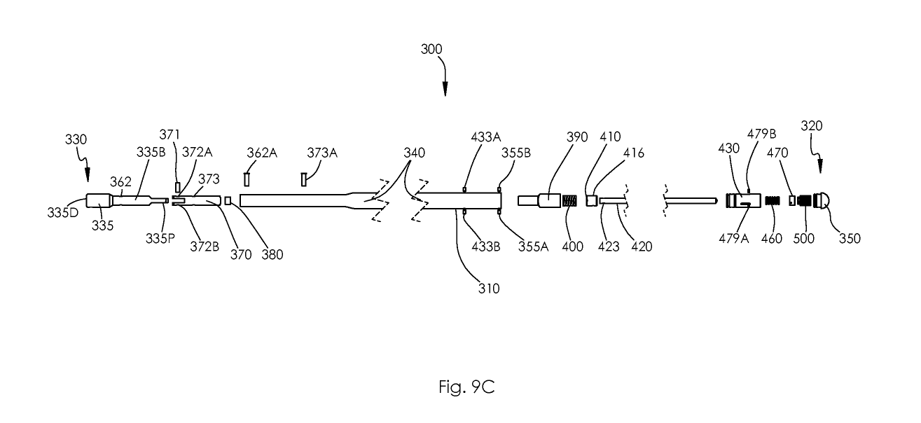

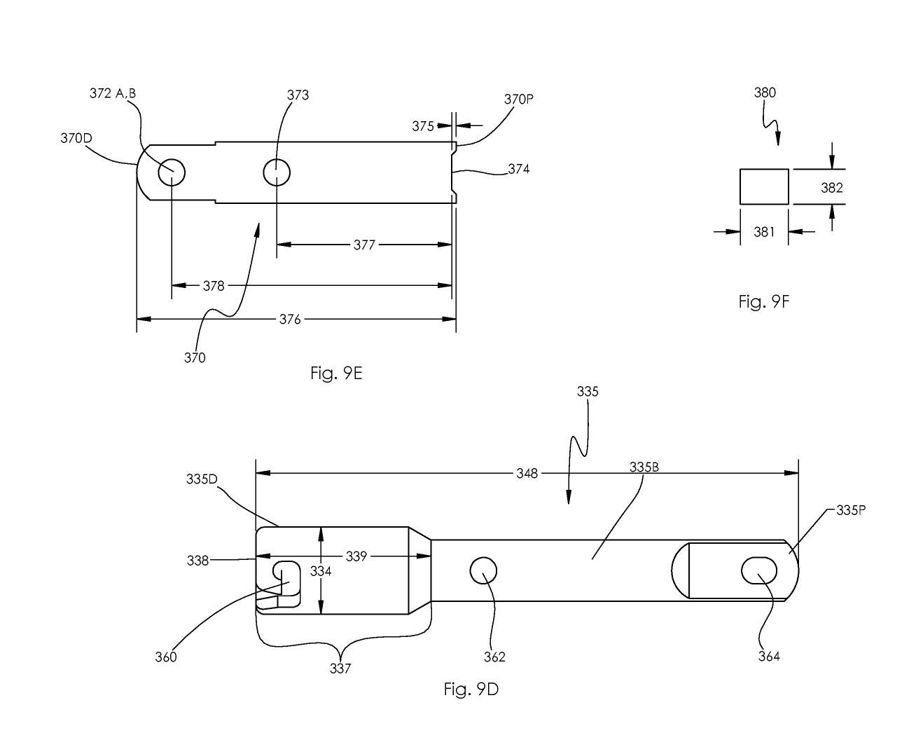

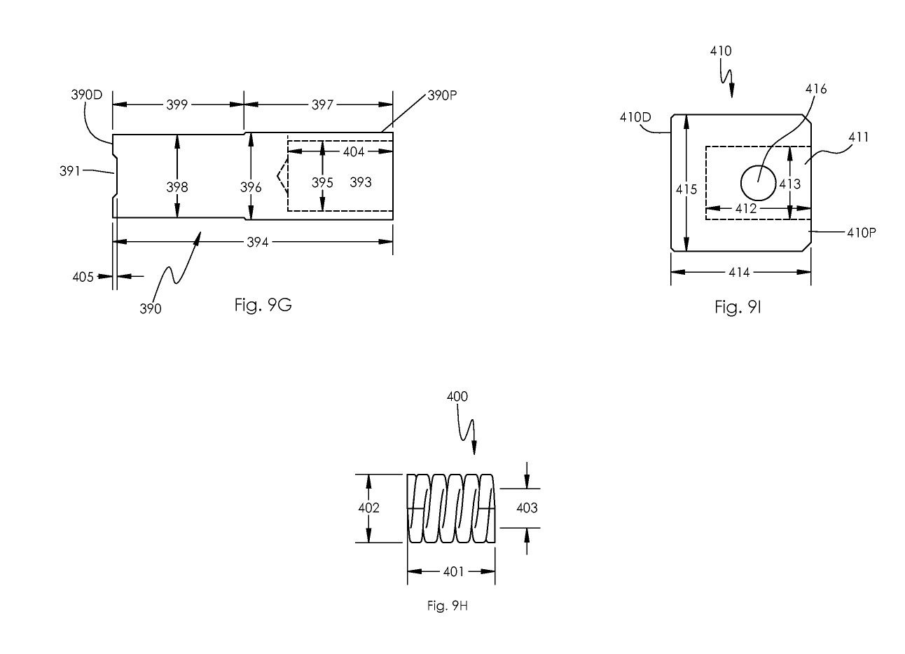

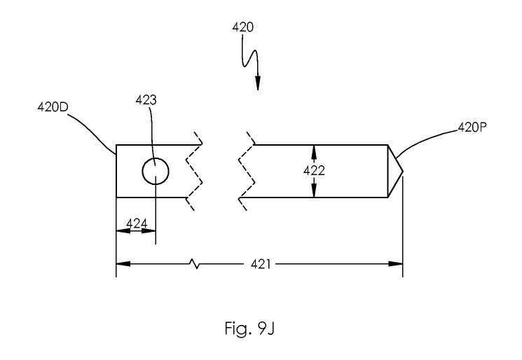

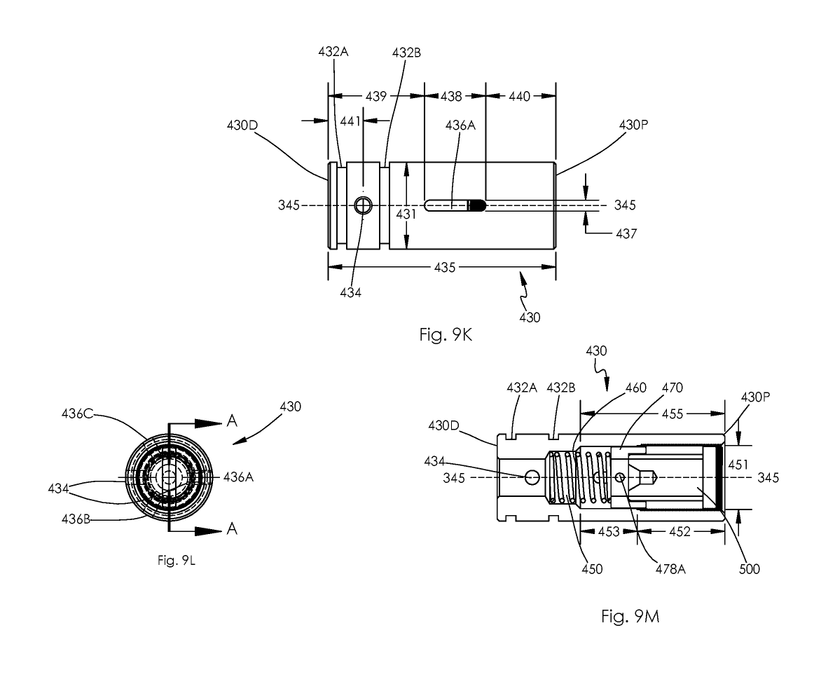

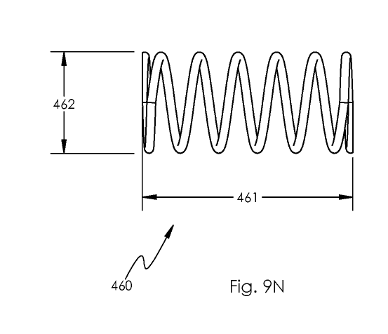

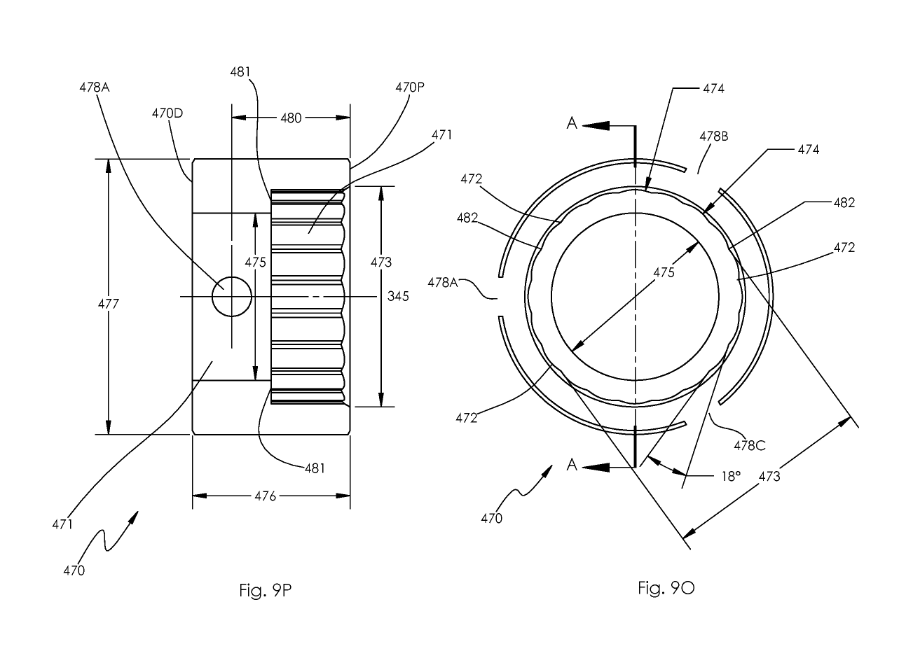

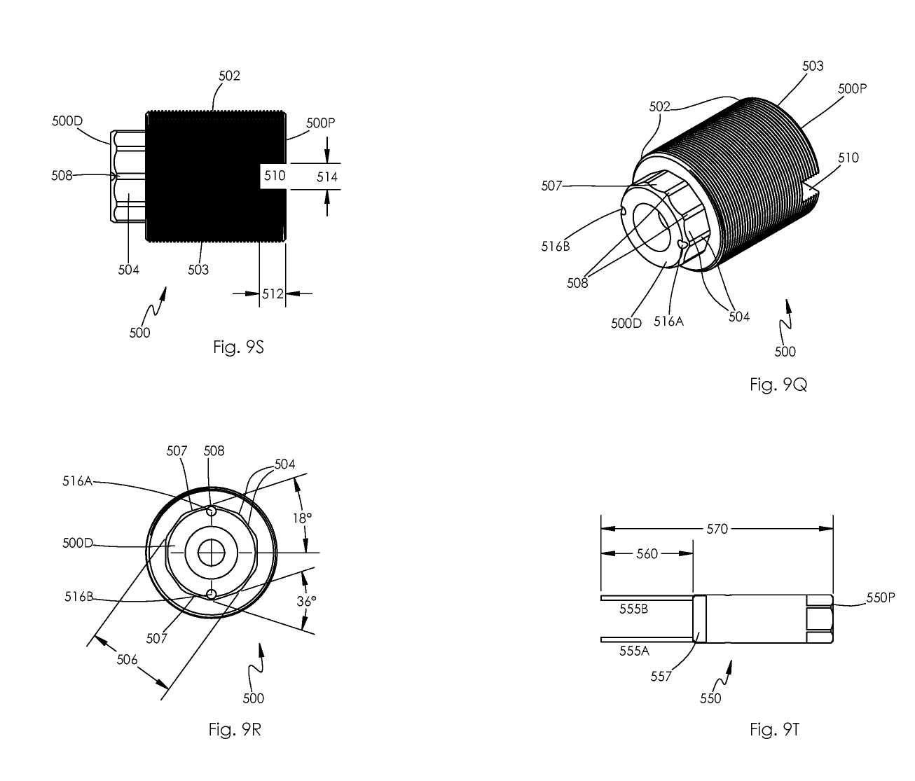

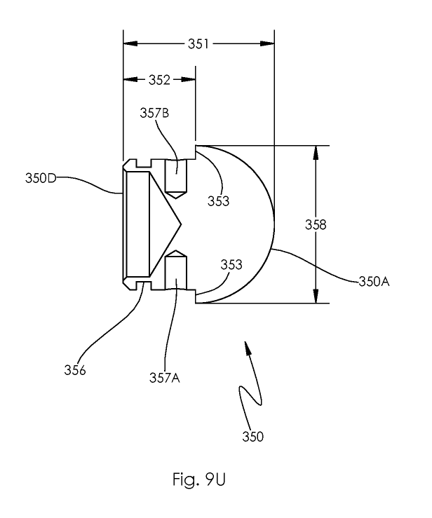

Turning now to FIGS. 9A-9S, depicted is an illustrative torqueing tool 300 for use in tightening a fitting F to a desired torque. FIG. 9A depicts a side view of an illustrative torqueing tool 300, FIG. 9B depicts a cross-sectional view of the torqueing tool 300 depicted in FIG. 9A in an exercised state, and FIG. 9C depicts an exploded view of the torqueing tool 300 depicted in FIG. 9A rotated by 90 degrees.

As shown in FIGS. 9A-9C, the torqueing tool 300 can have an elongate body 310 that has a proximal end 320, a distal end 330, and a lumen 340 (depicted in FIGS. 9B-9C). The lumen 340 can have a central axis 345 that extends within the lumen between the proximal end 320 and distal end 330 of the elongate body 310. The distal end 330 of the elongate body 310 is configured for insertion into an aperture AP of a fitting F for use in coupling pipe or tubing. The proximal end 320 of the elongate body 310 includes a cap 350 that can be rounded so as to provide for a comfortable way of gripping the proximal end 320 of the elongate body 310 during use of the torqueing tool 300. The elongate body 310 may also include ridges R (not depicted), such as may run the length of the outer surface of the elongate body 310 in a diamond formation to facilitate gripping of the torqueing tool 300. The elongate body 310 may also include a bore or eyelet for use in connecting the torqueing tool 300 to a safety lanyard.

FIG. 9D depicts a side view of an illustrative torque arm 335 of the invention. As shown collectively in FIGS. 9A-9D, the torque arm 335 that has a proximal end 335P, a distal end 335D, and a body 335B. The proximal end 335P of the torque arm 335 can be disposed within the lumen 340 of the distal end 330 of the elongate body 310 of the torqueing tool 300.

The distal end 335D of the torque arm 335 can extend beyond the lumen 340 of the elongate body 310, and can be configured for insertion into an aperture AP of a fitting F for use in coupling pipe or tubing. With reference to FIG. 9D, in certain embodiments, the distal end 335D of the torque arm 335 includes a cylindrical portion 337 configured for insertion into an aperture AP of a fitting F for use in coupling pipe or tubing. The cylindrical portion 337 can include a face 338 located at the distal end 335D of the torque arm 335, and a length 339 that extends in a proximal direction from the face 338 that defines the wall of the cylindrical portion 337 of the torque arm 335. The cylindrical portion 337 can include a diameter 334 that can be either uniform or variable along the length 339 of the cylindrical portion 337. The cylindrical portion 337 can also include a channel 360 for receiving a protrusion P in an aperture AP of a fitting F, such as a fitting F depicted in FIGS. 3A-3B. In certain embodiments, the channel 360 can occupy a “J” configuration so as to permit the torque arm 335 (and torqueing tool 300) to releasably interlock with a fitting F, such as when a user rotates the torqueing tool 300 while placing it into an aperture AP.

In other embodiments, the distal end 335D of the torque arm 335 can include other structures to releasably connect the torque arm 335 (and the torqueing tool 300) with a fitting F, such as those described herein. In some embodiments, for example, such as where a protrusion P is spring loaded, the distal end 335D of the torque arm 335 can include a small recess for mating with the spring loaded protrusion P so as to releasably connect a fitting F and the torqueing tool 300. In other embodiments, the distal end 335D of the torque arm 335 may include an aperture for receiving a portion of a fitting F, such as where the fitting includes one or more protrusions for tightening and/or loosening the fitting. Additionally, the distal end 335D of the torque arm 335 may be configured in any suitable configuration for receiving an aperture AP or protrusion, and may therefore occupy any suitable geometrical shape or void such as a rectangle, cube, triangular and square based prisms, rectangular prisms, hexagonal prisms, elongated cylinders, cones, partial spheres, and the like. Moreover, the distal end 335D of the torque arm 335 may include a structural component, such as a hook, claw, or the like, to catch a protrusion P within an aperture AP, such as where the protrusion P extends throughout the diameter of an aperture AP having a minimal depth AD. In certain embodiments, the distal end 335D of the torque arm 335 may be rounded such as to facilitate the entry of the distal end 335D into an aperture. The cylindrical portion 337 is similar in many respects to the cylindrical portion 230 discussed above in reference to FIGS. 8A-8B.

As shown in FIGS. 9B-9D, the torque arm 335 includes a distal hole 362 for securing the torque arm to the elongate body 310 of the torqueing tool 300 by use of cotter pin 362A (FIGS. 9A-9C) or similar device. The torque arm also include a proximal hole 364 that is located in a necked down or tongued region (see FIGS. 9C-9D) of the proximal end 335P of the torque arm 335. The proximal hole 364 of the torque arm 335 permits the torque arm 335 to be attached to the distal end 370D of a doubler arm 370, which encompasses the tongued portion of the torque arm's 335 proximal end 335P in a tongue and groove manner by pressing a cotter pin 371 or similar device through hole 364 of the torque arm and corresponding holes 372A, B in the distal end 370D of the doubler arm 370. The doubler arm 370 also includes a hole 373 for securing the doubler arm 370 to the elongate body 310 of the tightening tool by way of a cotter pin 373A or similar device.

After connecting the torque arm 335 and the doubler arm 370 with cotter pin 371, and connecting the torque arm 335 to the elongate body 310 with cotter pin 362A, and connecting the doubler arm 370 to the elongate body 310 with cotter pin 373A, the torque arm 335 and doubler arm 370 are free to move bi-directionally within the elongate body 310 between two positions, each of which is proximate to the wall of the elongate body 310. FIG. 9B depicts the torque arm 335 and doubler arm 370 in one of these two positions.

Returning now to FIG. 9E, the proximal end 370P of the doubler arm 370 includes a recessed area 374 for receipt of a pawl block 380, which is depicted in FIG. 9F. Turning to FIGS. 9C, adjacent to the pawl block in a proximal direction is the spring guide 390, which is also depicted in FIG. 9G. The spring guide 390 has a distal end 390D and a proximal end 390P. The distal end 390D of the spring guide 390 includes a recessed area 391 for receipt of the pawl block 380.

As depicted in FIG. 9B, the recessed area 374 of the doubler arm 370 and the recessed area 391 of the spring guide 390 are sized such that the pawl block 380 may rotate within the recessed areas as the torque arm 335 and doubler arm 370 move bi-directionally from wall to wall of the elongate body 310. By way of example, the recessed areas 374, 391 may extend all the way across the body of the respective doubler arm 374 and spring guide 390, such as when the pawl block 380 has the same length or diameter of the doubler arm 374 and spring guide 390, or may alternatively occupy only a portion of such doubler arm 374 and spring guide 390 diameter or length, such as where it is desirable to enclose the pawl block 380 within the recessed areas 374, 391, to prevent its movement across the diameter or length of the doubler arm 374 and spring guide 390. Illustratively, the pawl block 380 has a width 381 of 0.5 inches, a height 382 of 0.5 inches, and a length (not depicted) of 0.69 inches, however such dimensions may be varied as discussed herein, for example, by varying either the width 381 and/or height 382 to any specific measurement within the range of 0.2 to 1.2 inches. Additionally, in certain embodiments, the pawl block may take on other geometrical structures than a rectangular prism, such as a cylinder, such as when the recessed areas 374, 391 may be concave, for example.

Returning to FIG. 9G, the proximal end 390P of the spring guide 390 can include a lumen for receipt of a torque spring 400, which is depicted in FIG. 9H. The lumen 393 of the of the spring guide 390 can be formed using any conventional techniques, such as through a casting process for the spring guide 390 or by any suitable machining technique, such as drilling. In certain embodiments, the lumen 393 may be configured to receive the entirety of the torque spring 400 in its free length 401, as well as at least a portion of a push rod foot 410, which is depicted in FIG. 91. In other embodiments, the lumen 393 may only receive a portion of the torque spring 400 when the spring occupies its free length 401, as is appropriate. Illustratively, the spring guide 390 can have a length 394 of 4.0 inches and a lumen inner diameter 395 of 1 inches. The proximal end 390P of the spring guide 390 may be cylindrical with a diameter 396 of 1.25 inches and a length of 2.1 inches. The distal end 390D of the spring guide 390 may be cylindrical with a diameter 398 of 1.2 inches and a length 399 of 1.9 inches. The lumen 393 may have a depth 404 of 1.5 inches. The recessed area 391 may have a depth 405 of 0.063 inches, but the depth, like all dimensions herein, may be varied as desirable.

The illustrated torque spring 400 has a free length 401 of 1.25 inches, an outer diameter 402 of 1 inch, an internal diameter 403 of 0.5 inches, a spring rate of 1712 lbs per inch, a load rating at 15% of 321 lbs, and a maximum deflection of 0.375 inches at 30% deflection, although such dimensions are merely illustrative and may be varied in accordance with additional embodiments of the invention. For example, it is desirable for the components of the torqueing tool 300, such as the pawl block 380 and torque spring 400 to be sized to provide the torqueing tool 300 with suitable torque ranges, as are adjustable in small increments. Illustrative such torque ranges include 80 to 400 ft-lbs, 120 to 380 ft-lbs, 150 to 350 ft-lbs, and 200 to 350 ft-lbs, 250 ft-lbs to 350 ft-lbs, and 280 to 330 ft-lbs. Illustrative such adjustment increments include 10 ft-lbs, 5 ft-lbs, 3-ft-lbs, 2 ft-lbs, 1 ft-lbs, and 0.5 ft-lbs.

Depicted in FIG. 9I is a side view of an illustrative push rod foot 410 of the invention. The push rod foot 410 has a proximal end 410P, a distal end 410D, and a lumen 411. The lumen 411 can have a diameter 413 of 0.52 inches and a lumen depth 412 of 0.75 inches. The push rod foot can have a length 414 of 1 inch and an outer diameter 415 of 0.975 inches so it can be received within the lumen 393 of the spring guide 390. The push rod foot 410 can also include a hole 416 that extends throughout both walls of the push rod foot 410 that define the lumen 411 of the push rod foot 410. Such hole 416 can receive a cotter pin 417 (depicted in FIG. 9B) for connecting the push rod foot 410 to the push rod 420, which is depicted in FIG. 9J. Although the hole may occupy any suitable size, it can include a diameter of 0.25 inches or the like.

FIG. 9J depicts an illustrative push rod 420 of the invention, which can be generally cylindrical having a length 421 of 30.75 inches and a diameter 422 of 0.5 inches. The push rod can be hollow or can be solid, as is suitable. The push rod 420 has a proximal end 420P and a distal end 420D that includes a hole 423 for receiving cotter pin 417 which is used to secure the push rod 420 within the lumen 411 of the push rod foot 410, such as by pressing the cotter pin through holes 416 and 423. Illustratively, the center of hole 423 can be located a distance 424 of 0.38 inches from the distal end 420D of the push rod 420. The proximal end 420P of push rod 420 can include a conical shape that is configured to rest against the distal end 500D of the adjustment screw 500, as depicted in FIG. 9B.

Turning now to FIG. 9K, a side view of an illustrative adjustment housing 430 of the invention is depicted. FIG. 9L provides an end view of the adjustment housing 430 depicted in FIG. 9K, and FIG. 9M provides a cross-sectional view taken along line A-A of the adjustment housing 430 depicted in FIG. 9L. As shown, the adjustment housing 430 is generally cylindrical and has a distal end 430D and a proximal end 430P. The adjustment housing 430 can have an outer diameter 431 of 1.24 inches which is sufficient to permit the housing to fit inside the lumen 340 of the elongate body 310 of the torqueing tool 300. The distal end 430D of the adjustment housing 430 can include two grooves 432A, 432B, each of which can receive an o-ring in order to prevent moisture, dirt, and grime from entering the lumen 340 of the elongate body 310, given that the adjustment housing 430 is fixed to the elongate body 310 by pressing two cotter pins 433A, 433B (depicted in FIG. 9C) through a hole 434 that can extend through the entirety of the adjustment housing 430.

The adjustment housing 430 also has an overall length 435 which can be 3.25 inches. The adjustment housing can also include three elongate windows 436A-C, that can have a height 437 of 0.16 inches and a length 438 of 0.88 inches. The elongate windows 436A-C can be located at a distance 439 of 1.38 inches from the distal end 430D of the adjustment housing 430 and a distance 440 of 1 inch from the proximal end 430P of the adjustment housing 430. Additionally, the center of the hole 434 for receiving the cotter pins 433A, 433B can be located a distance 441 of 0.5 inches from the distal end 430D of the adjustment housing 430. Again, each of such dimensions is illustrative and may be varied in accordance with embodiments of the invention. For example, the height, length, position, and number of elongate windows 436A-C may be varied as is desirable to achieve certain embodiments of the invention. In some embodiments, for example, the adjustment housing 430 may have no elongate windows, and in other embodiments, the adjustment housing 430 may have one, two, four or more elongate windows as described in more detail below.

With reference now to FIG. 9M, the adjustment housing 430 can have a lumen 450 that can have an inner diameter 451 of 0.885 inches and a length 455 of 2.1 inches. A portion of the lumen 452 can include threads for receiving the adjustment screw 500. A portion of the lumen 453 located distally from the threaded lumen portion 452 can have a smooth bore for receiving the lock ring spring 460 and lock ring 470.

FIG. 9N depicts a side view of an illustrative lock ring spring 460 of the invention. Illustratively, the lock ring spring 460 has a length 461 of 1.5 inches and an outer diameter 462 of 0.72 inches, so as to be receivable within the lumen 450 of the adjustment housing 430 in a manner that permits the lock ring spring 460 to expand and compress as the adjustment screw 500 is adjusted. The lock ring spring 460 can illustratively be made of music wire, ASTM A228.

FIG. 9O depicts a front elevation view of an illustrative lock ring 470 of the invention, and FIG. 9P depicts a cross-sectional view taken along line A-A of the lock ring 470 depicted in FIG. 9O. As shown in FIG. 9O, the lock ring 470 includes a geometric pattern 472 in a lumen 471 having a first inner lumen diameter 473. The geometric pattern 472 is for permitting the lock ring 470 to interlock with the distal end 500D of the adjustment screw 500, such as when the lock ring spring 460 is pressing against the lock ring 470 in a sufficient manner so as to cause it to interlock with the adjustment screw 500. The geometric pattern 472 can include any suitable pattern and occupy any suitable inner lumen diameter 473 to achieve this intended functionality. In certain embodiments, for example, the inner lumen diameter 473 can be 0.659 inches across corresponding sections of the geometric pattern 472, such as when the geometric pattern comprises two (2) decagons turned 18 degrees to each other so as to provide twenty (20) arched sections 474 (each having a ⅛ inch radius) and twenty (20) knuckled areas 482 around the first lumen 471.

The lock ring 470 can also include a second lumen diameter 475 that is smaller than the first lumen diameter 473. Illustratively, the second lumen diameter 475 can be 0.53 inches. Additionally, the lock ring 470 can have a length 476 of 0.5 inches, and an outer diameter 477 of 0.88 inches. The outer diameter can be less than the lumen diameter 451 of the adjustment housing 430 so as to permit the lock ring 470 to slide in a bi-directional manner within the adjustment housing 430 along the central axis 345 of the elongate body 310. The lock ring 470 can include a proximal end 470P and a distal end 470D. Illustratively, the center of the holes 478A-C can reside a distance 480 of 0.375 inches from the proximal end 470P.

The lock ring 470 can also include three holes 478A-C for receiving a pin that resides in each of the elongate windows 436A-C of the adjustment housing 430. Such pins (two of which are shown as 479A-B in FIG. 9C) can be pressed in place in the lock ring 470 holes 478A-C and can reside flush with the outside wall of the elongate body 310 of the torqueing tool 300. The pins 479A-C prevent the lock ring from spinning within the lumen 450 of the adjustment housing 430 thereby preventing the adjustment screw 500 from moving when it is engaged with the lock ring 470. Given the elongated nature of the elongate windows 436A-C that interface with the pins 479A-C, however, the lock ring 470 is permitted to move bi-directionally within the adjustment housing 430 lumen 450 along the central axis 345 of the elongate body 310. Although three pins 479A-C are used to fixed the rotational position of the lock ring 470 in the illustrated embodiment, in other embodiments, the number of pins can vary, such as to include only a sing pin or to include four or more pins. In other embodiments, as well, the lock ring 470 can be rotationally fixated within the lumen 450 of the adjustment housing 430 using other means, such as by fixating pins in the lumen 450 of the adjustment housing 430 which interface with corresponding grooves in the outer surface of the lock ring 470. Alternatively, the lumen 450 of the adjustment housing 430 may also include a geometric pattern that corresponds with the outer surface of the lock ring 470 so as to prevent rotational movement of the lock ring 470 during its use.

Turning now to FIG. 9Q, a perspective view of an illustrative adjustment screw 500 is depicted. FIG. 9R shows a front elevation view of the adjustment screw 500 depicted in FIG. 9Q, and FIG. 9S depicts a side view of the same. As shown, adjustment screw 500 has a distal end 500D, a proximal end 500P, and a cylindrical body 502. The distal end 500D of the adjustment screw 500 can occupy a geometric pattern 504 that is configured to releasably interface with the geometric pattern 472 of the lock ring 470. As shown, the geometric pattern 504 can include ten (10) long regions 507 and ten (10) short regions 508 that permit the geometric pattern 504 to favorably interface with the geometric pattern 472 of the lock ring 470. In the depicted embodiment, the geometric pattern 472 of the lock ring 470 will encompass the geometric pattern 504 of the distal end 500D of the adjustment screw 500, given that the pattern's 504 diameter 506 diameter between the knuckles of the short regions 508 is 0.654 inches, thereby releasably interlocking the two components. Although any suitable geometric configuration can be used to releasably interlock the lock ring 470 and the adjustment screw 500, other embodiments also include using other interlocking structures, such as intermeshing gears, pins, or teeth and the like.

As shown in FIGS. 9Q and 9S, the body 502 of the adjustment screw 500 includes threads 503 which extend throughout substantially all of the body 502. The threads 503 can occupy and suitable pitch, such as 15/16 inch—40 UNC 3A threads. The proximal end 500P of the adjustment screw 500 can also include a recessed area 510 for releasably interfacing with the adjustment tool 550. Illustratively, the recessed area 510 includes a depth 512 of 0.19 inches and a width 514 of 0.188 inches, although like the other dimensions herein, these dimensions can be varied to any suitable dimension.

The adjustment screw 500 can also include two holes 516A, 516B that extend from the proximal end 500P of the adjustment screw 500 to the distal end 500D of the adjustment screw 500. The holes 516A, 516B are configured to receive two pins 555A. 555B pm the adjustment tool 550. When the cap 350 is removed from the elongate body 310 of the torqueing tool 300, the adjustment tool 550 can be releasably interfaced with the recessed area 510 of the adjustment screw 500.

Once the adjustment tool is located in the adjustment screw 500, the pins 555A, 555B extend through the adjustment screw 500, and contact the lip 481 that is formed by the first lumen diameter 473 and the second lumen diameter 475 of the lock ring 470 (see FIG. 9P), thereby pushing the lock ring 470 in a distal direction until the geometric pattern 472 of the lock ring 470 disengages from the geometric pattern of 504 of the distal end 500D of the adjustment screw 500, thereby permitting the adjustment screw 500 to be turned within the lumen 450 of the adjustment housing 430 and the corresponding set point of the torque wrench to be adjusted. As the adjustment screw 500 is adjusted with the adjustment tool 550, the torque spring 400 is either further tensioned or relaxed given that the proximal end 420P of the push rod is in contact with the distal end 500D of the adjustment screw 500 so as to cause compression or relaxation of the torque spring 400 as the adjustment screw 500 moves bi-directionally within the adjustment housing 430. If the torque spring 400 is further tensioned, then it takes more torque to move the torque arm 335 and doubler arm 370 from their inline position to a knuckled position against an inner wall of the lumen 340 of the elongate body 310 (see FIG. 9B) once the desired torque setting is achieved with the torqueing tool 300. If tension is removed from the torque spring 400, then it takes less force to move the torque arm 335 and doubler arm 370 from their inline position to a knuckled position against an inner wall of the lumen 340 of the elongate body 310 (see FIG. 9B) once the desired torque setting is achieved with the torqueing tool 300.

In certain embodiments, the lock ring spring 460 and the lock ring 470 are located distally of the adjustment screw 500. In alternative embodiments, however, the lock ring spring 460 and the ring 470 can be located distally of the adjustment screw 500, and the lock ring 470 can be disengaged from the adjustment screw 500 such as by pulling on a rod or similar structure that pulls the lock ring 470 and/or lock ring spring (such as where the spring 460 is attached to the lock ring) in a distal direction.

Additional embodiments are further contemplated herein, such as embodiments that have no adjustment housing 430 but instead configure the lumen 340 of the elongate body 310 so as to provide the functions of the adjustment housing 430 described herein.

Turning again to the Figures, when the adjustment tool 550 is removed and the pins 555A, 555B are withdrawn, the lock ring 470 moves in a proximal direction and the geometric pattern 472 of the lock ring engages with the geometric pattern 504 of the distal end 500D of the adjustment screw 500 so as to prevent further adjustment of the torque setting, such as may incidentally take place during use of the torqueing tool 300.

Illustratively, the pins 555A, 555B can have a length 560 of 1 and 5/16 inches and a diameter of 1/16 inches. The adjustment tool 550 can have an overall length 570 of 3 and 5/16 inches. The adjustment tool 550 can also have a configuration at its proximal end 550P to receive a socket wrench of any suitable size, such as ⅝ inches. The adjustment tool 550 can also include a stepped down area with suitable dimensions to releasably interconnect with the recessed area 510 of the adjustment screw 500.

Turning now to FIG. 9U, a side view of an illustrative cap 350 is depicted. The cap has a proximal end 350P and a distal end 350D. The cap is configured to fit into the proximal end 320 of the elongate body 310 by way of two set screws 355A, 355B (depicted in FIG. 9C) which screw into two set screw holes 357A, 357B located in the cap 350. The cap also includes a groove 356 for placement of an o-ring which will keep dirt and moisture from making its way into the lumen 340 of the elongate body 310 during use of the torqueing tool 300. The cap 350 can have an overall length 351 of 1.44 inches, a length 352 of 0.69 inches from the distal end 350D of the cap 350 to a lip 353, which interfaces with the proximal end 320 of the elongate body 310. The cap 350 can also have a height 358 at the lip 353 of 1.5 inches.

Returning to FIG. 9A, the torqueing tool 300 can have an overall length 347 of 48.75 inches in illustrative embodiments, but in other embodiments can have any suitable length, including inches, 36 inches, 48 inches, 60 inches and the like. Returning to FIG. 9D, the length 339 of the cylindrical portion 337 of the torque arm 335 can illustratively be 2.25 inches and the diameter 334 of the cylindrical portion 337 can be 1.25 inches. Additionally, the overall length 348 of the torque arm can be 7.75 inches in certain embodiments. The distance from the most proximal point on the proximal end 335P of the torque arm 335 and the center of the distal hole 362 of the torque arm 335 can be 4.5 inches, and the distance between the most proximal point on the proximal end 335P of the torque arm and most proximal point of the proximal hole 364 of the torque arm 335 is 0.312 inches. Returning now to FIG. 9E, the doubler arm 370 can have an overall length 376 of 4.56 inches, and a recess depth 375 of 0.063 inches. Additionally, the center line of the second hole 373 in the doubler arm 370 can be located a length 377 of 2.5 inches from the depth of the recessed area 374, and the center line of the holes 372A, 372B can be located a length of 4 inches from the depth of the recessed area 374 of the doubler arm 370.

The torqueing tool 300 and its components can be made of any suitable material, including carbon and stainless steel and their alloys. The components of the torqueing tool 200 can also be formed during any suitable alloy casting process, such as sand casting or investment casting, as are known in the art and as are described herein.

The torqueing tool 300 can be calibrated in the shop using a Norbar TCP 100-1000 calibration tool or equivalent. Once calibrated, the torqueing tool 300 can then be used on location in the field without the frequent need to recalibrate the tool.

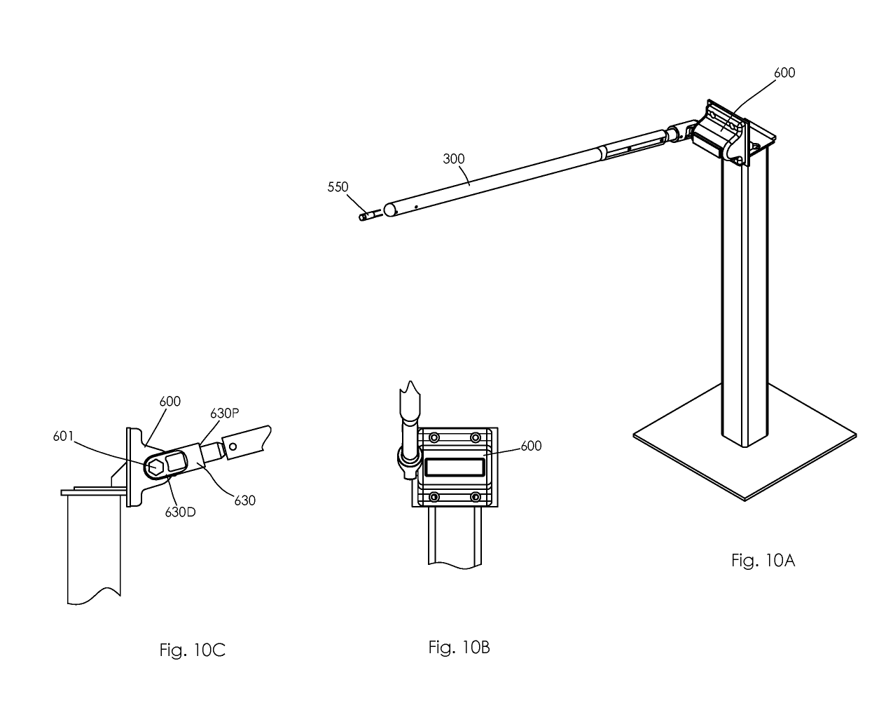

FIG. 10A depicts a perspective view of a torqueing tool 300 attached to a calibration tool 600 which is mounted on a calibration tool stand 620. As depicted in FIG. 10A, the cap 350 has been removed from the torqueing tool 300 so as to permit access to the adjustment screw 500. FIG. 10B depicts a partial front elevation view of a calibration tool receiving a torqueing tool 300 for calibration, and FIG. 10C depicts a side view of the same that includes an illustrative adapter 630 of the invention which permits a user to engage the distal end 330 of the elongate body 310 of the torqueing tool 330 with one end of the adapter, the proximal end 630P, yet connect the other end of the adapter, the distal end 630D, to the calibration tool 600 to permit ready calibration of the torqueing tool 300. The distal end 630D of the adapter 630 includes a cut out portion that permits the adapter to slide snuggly over the head-sided input post of the calibration tool 601. The distal end 630D of the adapter 630 can also include a set screw that is adjustable through the adapter 630 (such as by a threaded bore) and against the post of the calibration tool 601 so as to secure the adapter 630 to the post. The distal end 630D of the adapter 630 can be varied to accommodate other types of input posts, such as square posts and the like. The proximal end 630P of the adapter 630 is configured like the apertures AP discussed herein above.

All publications cited herein are hereby incorporated by reference in their entirety as if each had been individually incorporated by reference and fully set forth.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed is:

1. A tightening tool for use in tightening a fitting, comprising:
a unitary body, said unitary body having a proximal end and a distal end;
wherein said distal end of said unitary body is configured for insertion into an aperture of a fitting for use in coupling pipe or tubing; and
wherein said proximal end of said unitary body further comprises an aperture configured to receive a wrench for use in manipulating said tightening tool when said distal end of said tightening tool is inserted into an aperture of a fitting for use in coupling pipe or tubing.

2. The tightening tool of claim 1, wherein said distal end further comprises a cylindrical portion configured for insertion into an aperture of a fitting for use in coupling pipe or tubing.

3. The tightening tool of claim 2, wherein said cylindrical portion includes a face located at said distal end of said unitary body and a wall that extends in a proximal direction from said distal end of said unitary body.

4. The tightening tool of claim 3, wherein said proximal end of said unitary body further comprises a rectangular prism having a face located at said proximal end of said unitary body and a length extending in a distal direction from said cylindrical portion.

5. The tightening tool of claim 4, wherein said rectangular prism of said proximal end further comprises a width.

6. The tightening tool of claim 5, wherein said width of said rectangular prism of said proximal end is constant across said length of said rectangular prism of said proximal end.

7. The tightening tool of claim 6, wherein said cylindrical portion further comprises a channel for receiving a protrusion in an aperture of a fitting for use in coupling pipe or tubing so as to releasably interlock said tightening tool within the fitting.

8. The tightening tool of claim 7, wherein said channel is a “J” channel.

9. The tightening tool of claim 2, wherein said cylindrical portion occupies a diameter.

10. The tightening tool of claim 9, wherein said diameter of said cylinder is constant.

11. The tightening tool of claim 10, wherein said diameter of said cylinder is equal to said width of said rectangular prism.

12. The tightening tool of claim 11, wherein said aperture of said unitary body extends throughout the entirety of the width of said rectangular prism of said proximal end.

13. The tightening tool of claim 12, wherein said aperture of said unitary body comprises a rectangular prism.

14. The tightening tool of claim 1, wherein said unitary body comprises carbon steel.

15. A torqueing tool for use in tightening a fitting to a desired torque, comprising:
an elongate body having a proximal end, a distal end, and a lumen, said lumen having a central axis that extends within the lumen between said proximal end and said distal end of said elongate body;
a lock ring disposed within said lumen of said elongate body, said lock ring configured to move in a bidirectional manner along said central axis;
an adjustment screw disposed within said lumen of said elongate body, said adjustment screw configured to releasably interface with said lock ring so as to permit adjustment of the adjustment screw when the lock ring is disengaged from said adjustment screw and so as to prevent adjustment of said adjustment screw when said lock ring is engaged with said adjustment screw; and
a torque arm having a proximal end, a distal end, and a body, wherein said proximal end of said torque arm is disposed within said lumen and wherein said distal end of said torque arm is configured for insertion into an aperture of a fitting for use in coupling pipe or tubing.

16. The torqueing tool of claim 15, wherein said adjustment screw is located proximally from said lock ring.

17. The torqueing tool of claim 16, further comprising a release spring disposed within said lumen of said elongate body, said release spring further disposed distally from said lock ring in manner so as to exert force on said lock ring in a proximal direction toward said adjustment screw.

18. The torqueing tool of claim 17, wherein said adjustment screw further comprises at least one hole configured to receive a pin that disengages said lock ring from said adjustment screw when disposed through said at least one hole.

19. The torqueing tool of claim 15, wherein said distal end of said torque arm further comprises a cylindrical portion configured for insertion into an aperture of a fitting for use in coupling pipe or tubing.

20. The torqueing tool of claim 19, wherein said cylindrical portion further comprises a channel for receiving a protrusion in an aperture of a fitting for use in coupling pipe or tubing so as to releasably interlock said torqueing tool within the fitting.

21. The torqueing tool of claim 20, wherein said channel is a “J” channel.
